(19) United States
(12) Patent Application Publication
(10) Pub. No.: US 2019/0185063 A1
(43) Pub. Date: Jun. 20, 2019

(54) WORK VEHICLE

(71) Applicants: KOMATSU LTD., Tokyo (JP); NIPPON STEEL & SUMITOMO METAL CORPORATION, Tokyo (JP)

(72) Inventors: Makoto SASAKI, Minato-ku, Tokyo (JP); Masashi KATOH, Minato-ku, Tokyo (JP); Takahiro NOGUCHI, Minato-ku, Tokyo (JP); Kazuaki ADACHI, Minato-ku, Tokyo (JP); Yoshiaki NAKAZAWA, Chiyoda-ku, Tokyo (JP); Nobutaka SHIMIZU, Chiyoda-ku, Tokyo (JP); Masahiro NAKATA, Chiyoda-ku, Tokyo (JP)

(21) Appl. No.: 16/311,972

(22) PCT Filed: Aug. 10, 2017
(86) PCT No.: PCT/JP2017/029079

§ 371 Date: Dec. 20, 2018

(30) Foreign Application Priority Data
Aug. 10, 2016 (JP) 2016-157884

(51) Int. Cl. B62D 21/18; B62D 27/04; E02F 9/16; B62D 33/06

(52) U.S. Cl. CPC B62D 21/186; B62D 27/04; F16F 15/04; B62D 33/0604; E02F 9/16

(57) ABSTRACT

A work vehicle includes a cab, a body frame and a restrictor. The body flame includes a base component, and a support frame provided on an upper side of the base component. The support frame supports the cab. The restrictor is provided to a floor frame of the cab. The restrictor is disposed between the base component and the floor frame. The restrictor includes a retaining member disposed on a lower side of the support frame, and an impact absorber disposed on a cab side of the retaining member.

### CROSS-REFERENCE TO RELATED APPLICATIONS

This application is a U.S. National stage application of International Application No. PCT/JP2017/029079, filed on Aug. 10, 2017. This U.S. National stage application claims priority under 35 U.S.C. § 119(a) to Japanese Patent Application No. 2016-157884, filed in Japan on Aug. 10, 2016, the entire contents of which are hereby incorporated herein by reference.

### BACKGROUND

### Field of the Invention

The present invention relates to a work vehicle.

### Background Information

Conventionally, a restrictor is provided to prevent the cab from coming loose from the body frame when a work vehicle such as a hydraulic excavator topples and is subjected to a pressing force on the side of the cab (see JP-A 2004-189089, for example).

On the other hand, with the work vehicle in JP-A 2004-189089, the cab rear frame is made of a heavy-gauge material so that it will be stiff enough that the cab rear frame will not be deformed by an impact force from the side face of the cab in the event that the vehicle overturns, etc. Also, by disposing a restrictor near the stiffened cab rear frame allows any impact produced by the restriction caused by the restrictor during overturning can also be borne by the cab rear frame.

### SUMMARY

However, with the above-mentioned conventional work vehicle, the cab ended up being heavier.

It is an object of the present invention to provide a work vehicle with which the necessary strength can be ensured and the cab can be made lighter.

The work vehicle pertaining to the first aspect comprises a cab, a body frame, and a restrictor. The body frame has a base component, and a support frame that is provided on the upper side of the base component and supports the cab. The restrictor has a retaining member and an impact absorber. The retaining member is disposed on the lower side of the support frame. The impact absorber is disposed on the cab side of the retaining member.

Providing the impact absorber to the restrictor allows at least some of the impact generated in the cab due to restriction during overturning of the work vehicle to be absorbed through plastic deformation. Accordingly, the impact generated in the cab can be alleviated, and the frame of the cab need not be made of a heavy-gauge material, and so can be made thinner.

Therefore, it is possible to further reduce the weight of the cab.

The work vehicle pertaining to the second aspect is the work vehicle pertaining to the first aspect, further comprising a damper. The damper is provided to the body frame, supports the cab, and damps vibrations in the cab.

It is possible to alleviate vibrations and impacts occurring in the cab during normal use such as when the work vehicle is travelling or working.

Also, if the work vehicle topples or collides with a rock or the like, the restrictor can keep the cab from separating from the body frame.

The work vehicle pertaining to the third aspect is the work vehicle pertaining to the first aspect, further comprising a work implement that is disposed on the body frame. The restrictor is provided on the opposite side from the work implement.

Since there is a high probability that an impact will be exerted on the side of the cab where the work implement is not provided, providing the restrictor on the opposite side from the work implement is an effective way to keep the cab from separating from the body frame.

The work vehicle pertaining to the fourth aspect is the work vehicle pertaining to the first aspect, wherein the cab has a first cab frame and a second cab frame. The first cab frame is formed in the up and down direction on the opposite side of the cab from the side on which the work implement is disposed. The second cab frame is formed in the up and down direction on the opposite side of the cab from the side on which the work implement is disposed, and is lower in stiffness than the first cab frame. The restrictor is provided in a vicinity below the first cab frame and in a vicinity below the second cab frame. The coefficient of elasticity of the impact absorber of the restrictor provided in the vicinity below the second cab frame is lower than the coefficient of elasticity of the impact absorber of the restrictor provided in the vicinity below the first cab frame.

Because of this difference in the coefficient of elasticity, an impact exerted on the first cab frame will be greater than that on the second cab frame when an impact is exerted on the cab, but since the first cab frame is stiffer than the second cab frame, the impact can be stopped.

For example, when driving the work vehicle, the driver can focus on what is in front of the cab, so it is unlikely that there will be an impact caused by collision or the like on the front side of the cab, but since the driver cannot focus his attention to the rear, an impact is more likely on the rear side. The weight of the cab can be minimized by making the cab frame on the front side, which is less likely to be subjected to impact, from a lighter gauge material than the cab frame on the rear side, which is more likely to receive an impact. Also, even if an impact is exerted on the cab frame on the thinned front side, since the coefficient of elasticity is set lower, the impact can be absorbed.

The work vehicle pertaining to the fifth aspect is the work vehicle pertaining to the first aspect, wherein the impact absorber is fixed directly or indirectly to the floor frame of the cab.

When an impact causes the cab to move away from the vehicle body frame, the retaining member hits the support frame of the vehicle body frame from the below, and the movement of the cab is restricted. At the time of this contact, the impact absorber is pulled, which moderates the impact through plastic deformation of the impact absorber.

The work vehicle pertaining to the sixth aspect is the work vehicle pertaining to the fifth aspect, wherein the impact absorber has a first cylindrical section, a second cylindrical section, and a connecting portion. The first cylindrical section is fixed to the retaining member. The second cylindrical section is fixed to the floor frame of the cab, and its lower end is positioned lower than the upper end of the first cylindrical section.

An elastic force is generated by the bending of the connecting portion of the impact absorber, which lessens the collision of the retaining member against the support frame.

The work vehicle pertaining to the seventh aspect is the work vehicle pertaining to the fifth aspect, wherein the impact absorber is a spring member. The upper end of the impact absorber is fixed to the floor frame of the cab, and its lower end is fixed to the retaining member.

When a spring member is provided, the collision of the retaining member against the support frame can be lessened by the elastic force of the spring member.

The work vehicle pertaining to the eighth aspect is the work vehicle pertaining to the fifth aspect, wherein the impact absorber is a rubber member. The impact absorber is fixed to the floor frame of the cab via a first metal member that is bonded to the impact absorber and is fixed to the floor frame of the cab, and is fixed to the retaining member via a second metal member that is bonded to the impact absorber and is fixed to the retaining member.

When a rubber member is provided, the collision of the retaining member against the support frame can be lessened by the elastic force of the rubber member.

The work vehicle pertaining to the ninth aspect is the work vehicle pertaining to the fifth aspect, wherein the upper face of the retaining member is curved so that its position becomes lower moving toward the outer peripheral side.

The portion of the retaining member that collides with the supporting frame of the body frame is formed in a curved shape. This makes it less likely that there will be one-sided contact of the retaining member against the support frame when the cab is tilted with respect to the body frame.

The work vehicle pertaining to the tenth aspect is the work vehicle pertaining to the first aspect, wherein the restrictor further has a linking member that links the floor frame and the retaining member. The impact absorber is fixed to the retaining member and is disposed lower than the support frame.

When an impact causes the cab to move away from the body frame, the impact absorber hits the supporting frame of the body frame from below, and the movement of the cab is restricted. At the time of this contact, the impact absorber is compressed, and the impact can be lessened by the energy generated by deformation (either elastic deformation or plastic deformation) of the impact absorber.

The work vehicle pertaining to the eleventh aspect is the work vehicle pertaining to the tenth aspect, wherein the impact absorber has a first cylindrical section, a second cylindrical section, and a connecting portion. The first cylindrical section is fixed to the retaining member. The lower end of the second cylindrical section is positioned lower than the upper end of the first cylindrical section. The connecting portion connects the upper end of the first cylindrical section and the lower end of the second cylindrical section.

An elastic force is generated by the bending of the connecting portion of the impact absorber, which lessens the collision of the impact absorber against the support frame.

The work vehicle pertaining to the twelfth aspect is the work vehicle pertaining to the tenth aspect, wherein the impact absorber is a spring member or a rubber member.

When a spring member or a rubber member is provided, collision of the impact absorber against the supporting frame can be lessened by the elastic force of the spring member or rubber member.

The work vehicle pertaining to the thirteenth aspect is the work vehicle pertaining to the third aspect, wherein the retaining member is a plate-shaped member disposed such that a main face thereof is opposite the supporting frame. The restrictor is disposed such that the end of the main face on the work implement side is higher than the end on the opposite side from the work implement.

Disposing the restrictor at an angle makes it less likely that there will be one-sided contact of the restrictor with the body frame when the cab tilts toward the work implement side with respect to the body frame.

The work vehicle pertaining to the fourteenth aspect is the work vehicle pertaining to the first aspect, wherein the impact absorber has an insertion component and a protruding portion. The insertion component is inserted into a through-hole formed in the floor frame of the cab. The protruding portion is provided above the floor frame and is formed so as to protrude from the insertion component to further outside than the through-hole. The protruding portion is curved so that its position becomes higher moving toward the outer peripheral side, and has a lower face that comes into contact around the periphery of the through-hole.

Since the protruding portion of the impact absorber has a lower face that is curved toward the through-hole side, it is less likely that there will be one-sided contact of the impact absorber around the periphery of the through-hole when the cab is tilted with respect to the body frame.

The work vehicle pertaining to the fifteenth aspect is the work vehicle pertaining to the fourteenth aspect, wherein the insertion component has a first cylindrical section, a second cylindrical section, and a connecting portion. The first cylindrical section is fixed to the retaining member. The second cylindrical section is inserted into the through-hole, and its lower end is located lower than the upper end of the first cylindrical section. The connecting portion connects the upper end of the first cylindrical section and the lower end of the second cylindrical section.

An elastic force is generated by the bending of the connecting portion of the impact absorber, which lessens the collision of the impact absorber against the support frame.

The present invention provides a work vehicle with which the necessary strength can be ensured and the weight of the cab can be reduced.

### BRIEF DESCRIPTION OF DRAWINGS

FIG. 1 is an oblique view of a hydraulic excavator in Embodiment of the present invention;

FIG. 2 is an oblique view of the body frame and the cab of the hydraulic excavator in FIG. 1;

FIG. 3 is an exploded oblique view showing a state in which the cab has been removed from the body frame in FIG. 2;

FIG. 4 is an oblique view illustrating the positional relation between the body frame and the cab in FIG. 2;

FIG. 5 is a cross section along the arrow G-G′ in FIG. 2;

FIG. 6 is a diagram showing the area near the left end as viewed along the arrow H in FIG. 5;

FIG. 7 is a cross section along the I-I′ line in FIG. 6;

FIG. 8 is a cross section of the configuration of the restrictor in Embodiment 2 of the present invention;

FIG. 9 is a cross section of the configuration of the restrictor in Embodiment 3 of the present invention;

FIG. 10 is cross section of the configuration of the restrictor in Embodiment 4 of the present invention;

FIG. 11 is cross section of the configuration of the restrictor in Embodiment 5 of the present invention;

FIG. 12 is cross section of the configuration of the restrictor in Embodiment 6 of the present invention;

FIG. 13 is cross section of the configuration of the restrictor in Embodiment 7 of the present invention;

FIG. 14 is cross section of the configuration of the restrictor in Embodiment 8 of the present invention; and

FIG. 15 is cross section of the configuration of the restrictor in Embodiment 9 of the present invention.

### DETAILED DESCRIPTION OF EMBODIMENT(S)

A hydraulic excavator will be described as an example of the work vehicle of the present invention through reference to the drawings.

### Embodiment 1

The hydraulic excavator in Embodiment 1 of the present invention will now be described.

Configuration

### Overall Configuration of Hydraulic Excavator 100

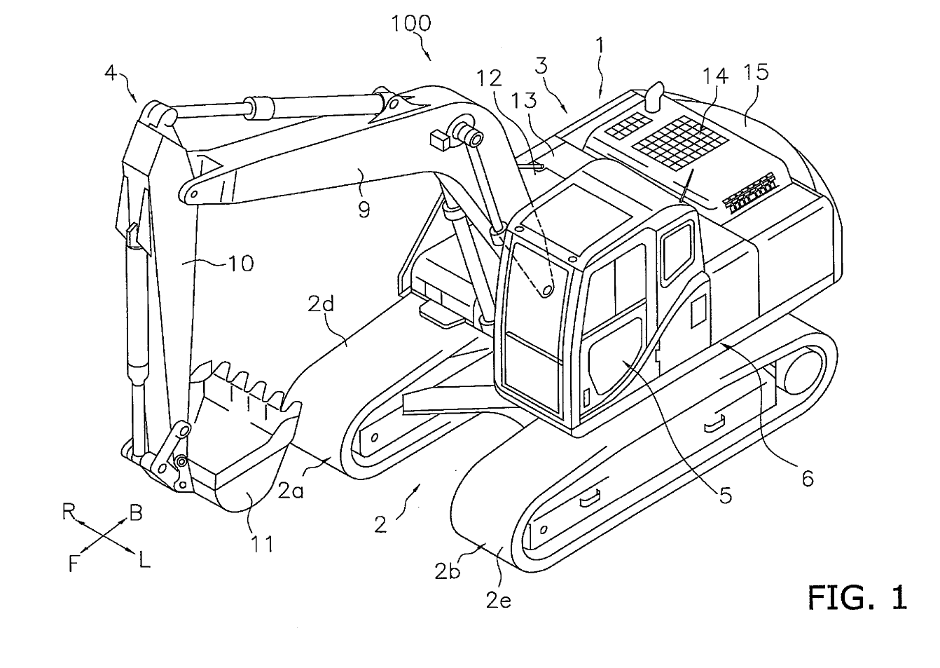

FIG. 1 is a diagram of a hydraulic excavator 100 according to an embodiment of the present invention. The hydraulic excavator 100 comprises a vehicle body 1 and a work implement 4.

The vehicle body 1 has a traveling unit 2 and a rotating unit 3. The traveling unit 2 has a pair of traveling devices 2a and 2b. The traveling devices 2a and 2b have crawler belts 2d and 2e, respectively.

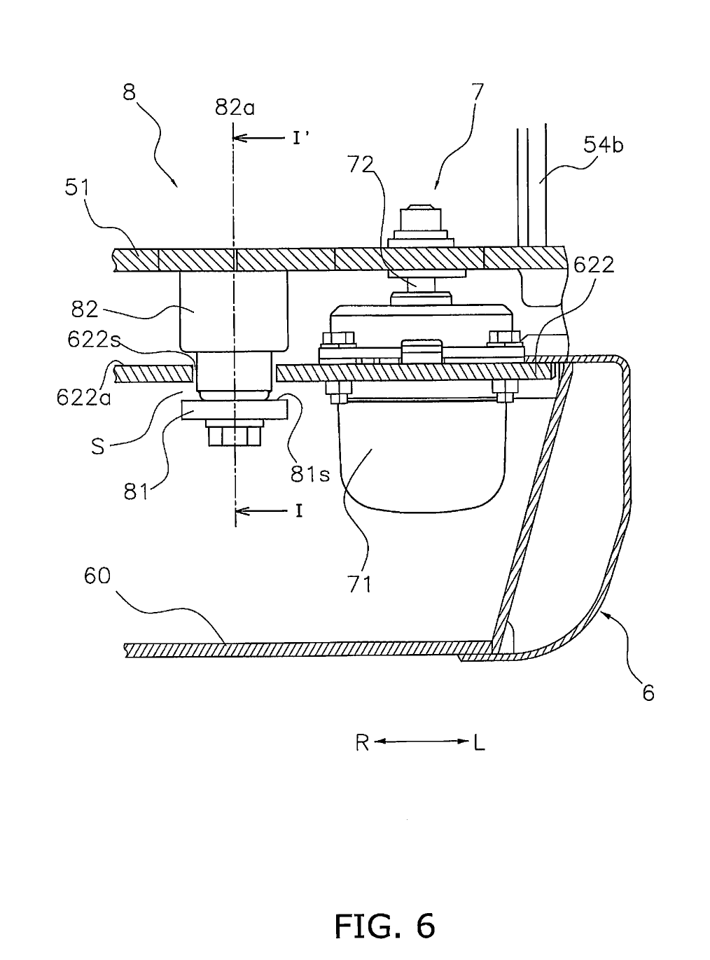

The rotating unit 3 is mounted on the traveling unit 2. The rotating unit 3 is provided so as to be able to rotate with respect to the traveling unit 2. The rotating unit 3 has a cab 5, a body frame 6, a damper 7 (see FIG. 6 (discussed below)), and a restrictor 8 (see FIG. 6 (discussed below)).

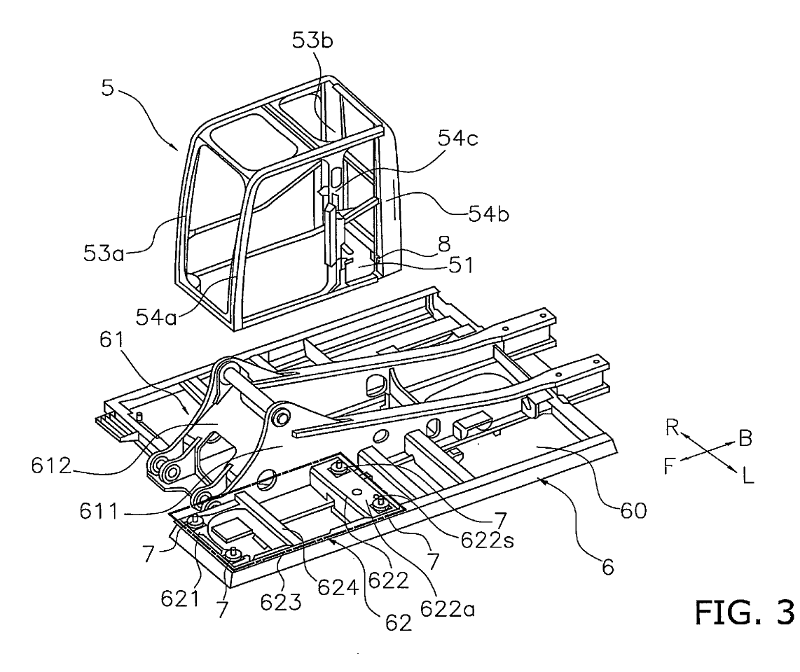

The body frame 6 is disposed on the upper side of the traveling unit 2. The cab 5 is disposed at the front-left position of the body frame 6. As shown in FIG. 3 (discussed below), a plurality of dampers 7 are provided to the body frame 6 and support the cab 5. As shown in FIG. 6 (discussed below), the restrictor 8 restricts the cab 5 from being separated from the body frame 6 in the event of overturning or collision.

In the description of the overall structure, the longitudinal direction means the longitudinal direction of the cab 5. Also, the longitudinal direction of the vehicle body 1 is assumed to coincide with the longitudinal direction of the cab 5, that is, the rotating unit 3. Also, the left and right direction, or to the side, refers to the vehicle width direction of the vehicle body 1. In FIG. 1, the forward direction is indicated by the arrow F, and the backward direction is indicated by the arrow B. Also, the right direction is indicated by the arrow R, and the left direction is indicated by the arrow L.

The rotating unit 3 further has a fuel tank 12, a hydraulic fluid tank 13, an engine compartment 14, a counterweight 15, and so forth. The fuel tank 12, the hydraulic fluid tank 13, the engine compartment 14, the counterweight 15, and so on are disposed on the body frame 6, to the rear of the cab 5.

As shown in FIG. 1, the work implement 4 is attached to the front central position of the rotating unit 3, and has a boom 9, an arm 10, and an excavation bucket 11. The proximal end of the boom 9 is rotatably supported by the body frame 6. The distal end of the boom 9 is rotatably linked to the proximal end of the arm 10, and the distal end of the arm 10 is rotatably linked to the excavation bucket 11.

The cab 5 is disposed on the left L side of the work implement 4.

Cab 5

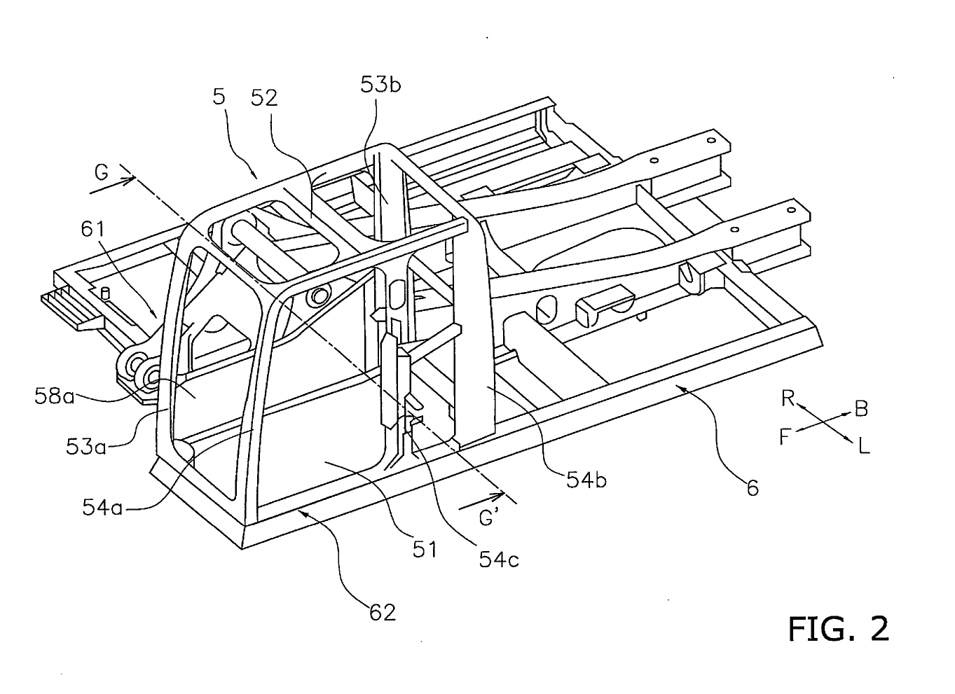

FIG. 2 is an oblique view of the body frame 6 and the cab 5.

The cab 5 has a floor frame 51, a ceiling frame 52, a right-front support 53a and a right-rear support 53b on the right face side, a left-front support 54a, a left-rear support 54b, and a left-middle support 54c on the left face side.

The right-front support 53a, the right-rear support 53b, the left-front support 54a, the left-rear support 54b, and the left-middle support 54c are formed facing upward from the floor frame 51, and are each connected to the ceiling frame 52.

The right-front support 53a is provided at the end on the right R side of the front face of the cab 5, and the right-rear support 53b is provided at the end on the right R side of the rear face of the cab 5.

The left-front support 54a is provided at the end on the left L side of the front face of the cab 5, and the left-rear support 54b is provided at the end on the left L side of the rear face of the cab 5. The left-middle support 54c is provided on the left side face of the cab 5, in between the left-front support 54a and the left-rear support 54b. The right-front support 53a and the left-front support 54a are disposed opposite each other in the left and right direction, and the right-rear support 53b and the left-rear support 54b are disposed opposite each other in the left and right direction. The support opposite the left-middle support 54c is not formed on the right side face, but a panel 58a connecting the support 53a and the support 53b is provided to the lower part of the right side face.

The right-rear support 53b and the left-rear support 54b on the rear face side are formed thicker than the right-front support 53a and the left-front support 54a on the front face side, and are therefore stiffer.

Body Frame 6

FIG. 3 is an oblique view showing a state in which the cab 5 and the body frame 6 are separated. The body frame 6 has a substantially planar base component 60, a work implement support 61 that supports the work implement 4, and a cab platform 62 on which the cab 5 is disposed.

The work implement support 61 is formed at the front-center position of the base component 60 of the body frame 6. As shown in FIG. 3, the work implement support 61 has a pair of opposing vertical plates 611 and 612 formed along the longitudinal direction. The proximal end of the boom 9 is rotatably disposed between the vertical plates 611 and 612. The cab 5 is disposed on the left side of the vertical plate 611, which is disposed on the left side.

The cab platform 62 is formed just to the left of the work implement support 61, at the front-left position of the base component 60. The cab platform 62 has a front support frame 621 disposed in the left and right direction on the base component 60, a rear support frame 622 disposed in the left and right direction on the base component 60, and a left support frame 623 that connects the left end of the rear support frame 622 and the front support frame 621. A middle support frame 624 is provided in the left and right direction between the front support frame 621 and the rear support frame 622.

Dampers 7

The dampers 7 damp vibrations occurring in the cab 5 during normal running and working.

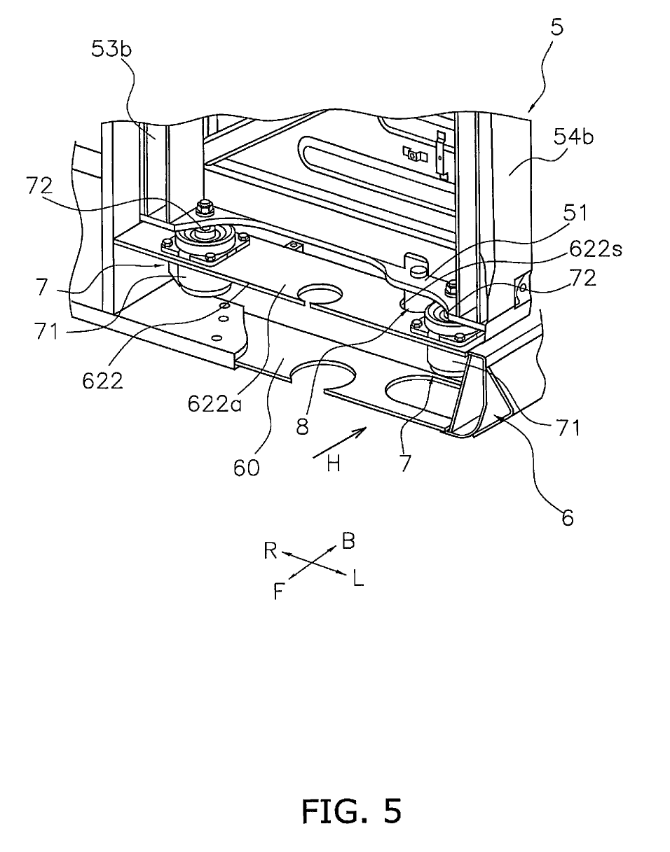

As shown in FIG. 3, holes are formed at the left and right ends of the upper face of the front support frame 621, and the dampers 7 is disposed in these holes. Also, holes are formed at the left and right ends of the upper face 622a (see FIG. 5) of the rear support frame 622, and the dampers 7 are disposed in these holes.

The cab 5 is disposed on the upper side of these four dampers 7. The cab 5 is supported on the body frame 6 by the dampers 7.

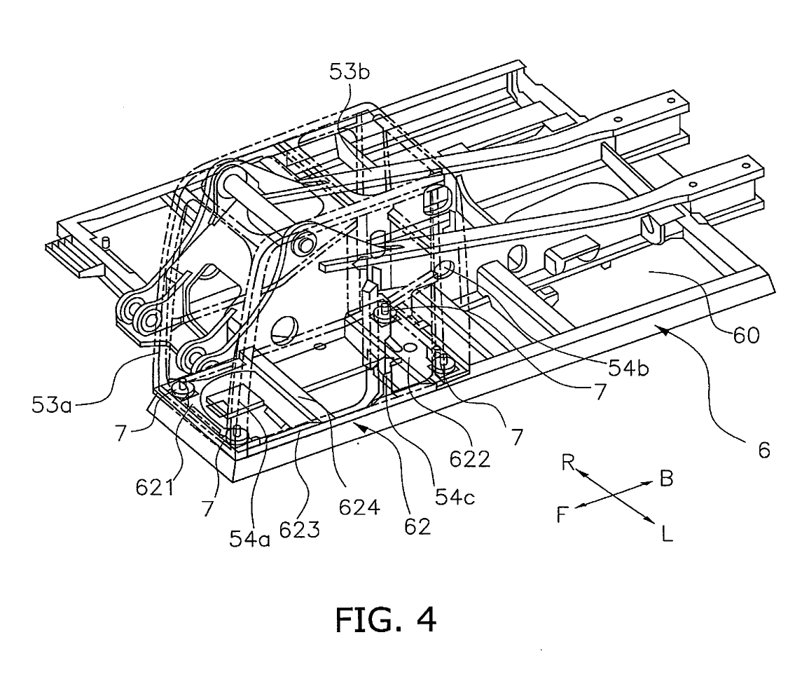

FIG. 4 is a diagram showing the positional relation between the body frame 6 and the cab 5. In FIG. 4, the cab 5 is indicated by a two-dot chain line. As shown in FIG. 4, the dampers 7 are disposed in the lower vicinity of the supports 53a, 53b, 54a, and 54b.

FIG. 5 is a cross section along the G-G′ line in FIG. 2. The dampers 7 each have a case 71 in the interior of which a coil spring or the like is provided, and a stud 72 protruding upward from the case 71. The case 71 is fixed to the upper face 622a of the rear support frame 622, and the upper end of the stud 72 is fixed to the floor frame 51 of the cab 5.

Restrictor 8

The restrictor 8 restricts the cab 5 from being separated from the body frame 6 in the event of overturning, collision, or the like. FIG. 6 is a view as seen in the direction of the arrow H in FIG. 5.

As shown in FIG. 6, the restrictor 8 is disposed in the vicinity of the right side of the damper 7 disposed on the side of the rear support frame 622 with the left face side (the arrow L side) of the cab 5. The restrictor 8 is fixed to the floor frame 51 of the cab 5 and is disposed to pass through a through-hole 622s formed in the upper face 622a of the rear support frame 622.

The restrictor 8 has a retaining member 81 and an impact absorber 82.

The retaining member 81 is disk shaped, and is formed metal, for example. The retaining member 81 is disposed lower than the upper face 622a of the rear support frame 622 so that the upper face 81s, which is the main face thereof, is opposite the through-hole 622s. The retaining member 81 is formed larger in diameter than the through-hole 622s.

The impact absorber 82 is provided on the cab 5 side of the retaining member 81. The impact absorber 82 has a substantially cylindrical shape in which two steel pipes having different diameters appear to be overlapping one over the other, and the center axis 82a of the cylinder is disposed in the vertical direction. The impact absorber 82 has elasticity and is inserted into the through-hole 622s.

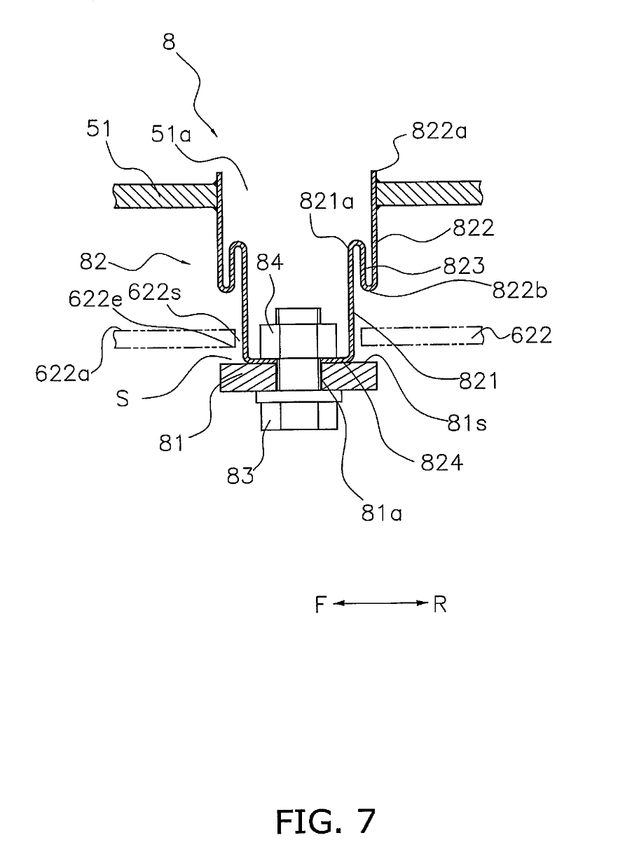

FIG. 7 is a cross section along the I-I′ line in FIG. 6. As shown in FIG. 7, the impact absorber 82 is formed by a steel pipe, and has a first cylindrical section 821, a second cylindrical section 822, a connecting portion 823, and a lid 824.

The first cylindrical section 821 is inserted through the through-hole 622s, and a slight gap is provided between the first cylindrical section 821 and the edge of the through-hole 622s.

The lid 824 is connected to the lower end of the first cylindrical section 821, and the lid 824 is disposed so as to block off the opening at the lower end of the first cylindrical section 821. The retaining member 81 has a through-hole 81a formed in the vertical direction, and a through-hole is also formed in the lid 824.

A bolt 83 is inserted into the through-hole 81a of the retaining member 81 and the through-hole of the lid 824 from below. A nut 84 is disposed on the upper side of the lid 824, and the nut 84 and the bolt 83 are threaded together. The lid 824 and the first cylindrical section 821 are fixed to the retaining member 81 by the bolt 83 and the nut 84.

The second cylindrical section 822 is formed larger in diameter than the first cylindrical section 821. The second cylindrical section 822 is disposed coaxially with the first cylindrical section 821 (on the central axis 82a shown in FIG. 6). The upper end 822a of the second cylindrical section 822 is fixed to the edge of the through-hole 51a formed in the floor frame 51 of the cab 5, by welding or the like. The lower end 822b of the second cylindrical section 822 is normally positioned lower than the upper end 821a of the first cylindrical section 821.

The connecting portion 823 connects the upper end 821a of the first cylindrical section 821 and the lower end 822b of the second cylindrical section 822. The connecting portion 823 has a cylindrical shape at the center in the vertical direction, and its upper end curves inward and is connected to the upper end 821a of the first cylindrical section 821, and its lower end curves outward and is connected to the lower end 822b of the second cylindrical section 822. Since the connecting portion 823 is curved and connected to the first cylindrical section 821 and the second cylindrical section 822, the impact absorber 82 has elasticity.

For example, if the hydraulic excavator 100 in this embodiment topples, or if an object strikes the hydraulic excavator 100, and the cab 5 is subjected to an impact, the cab 5 is restricted from separating from the body frame 6 because the retaining member 81 hits the upper face 622a (the edge 622e of the through-hole 622s) of the rear support frame 622, and the impact in this restriction is moderated by the elastic force of the impact absorber 82.

In a state in which the hydraulic excavator 100 is stopped, a gap S is formed between the retaining member 81 and the upper face 622a. This gap S is formed so that the retaining member 81 does not tough the upper face 622a within the vertical vibration range of the cab 5 during normal use of the hydraulic excavator 100. This is because when the retaining member 81 comes into contact with the upper face 622a during normal use, it affects the damping function of the dampers 7 with respect to vibration of the cab 5.

### Embodiment 2

A restrictor 108 used in the hydraulic excavator in Embodiment 2 of the present invention will now be described.

The hydraulic excavator 100 in Embodiment 2 differs from Embodiment 1 in the configuration of the restrictor. Therefore, in Embodiment 2 the description will focus on the configuration of the restrictor. In Embodiment 2, those components that are the same as in other embodiments will be numbered the same and will not be described again. This also applies to the embodiments given below.

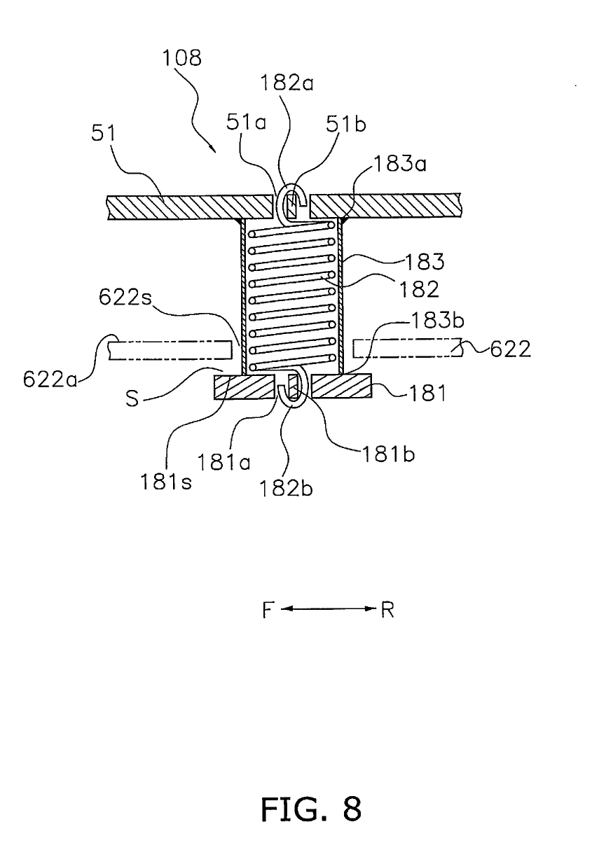

FIG. 8 is a cross section of the configuration of the restrictor 108 in Embodiment 2.

The restrictor 108 in Embodiment 2 has a retaining member 181, an impact absorber 182, and a cylindrical member 183. The retaining member 181 is disk shaped, and is disposed so that its upper face 181s (a main face) is opposite the through-hole 622s. The retaining member 181 is disposed lower than the upper face 622a of the rear support frame 622, and is formed to have a larger diameter than the through-hole 622s.

The impact absorber 182 is a coiled spring member, and is disposed closer to the cab 5 side than the retaining member 181. The impact absorber 182 is disposed through the through-hole 622s so that its central axis extends in the up and down direction. The upper end 182a of the impact absorber 182 is fixed to the floor frame 51. A through-hole 51a is formed in the floor frame 51, and a protrusion 51b is formed from the edge of the through-hole 51a toward the inside of the through-hole 51a. The upper end 182a of the impact absorber 182 is latched to the protrusion 51b.

On the other hand, the lower end 182b of the impact absorber 182 is fixed to the retaining member 181. A through-hole 181a is formed in the retaining member 181 in the up and down direction. A protrusion 181b is formed from the edge of the through-hole 181a toward the inside of the through-hole 181a. The lower end 182b of the impact absorber 182 is latched to the protrusion 181b.

The cylindrical member 183 is disposed on the outside of the impact absorber 182. The upper end 183a of the cylindrical member 183 is joined to the floor frame 51 by welding or the like. The cylindrical member 183 is inserted into the through-hole 622s of the rear support frame 622. The lower end 183b of the cylindrical member 183 is in contact with the retaining member 181. A gap S between the retaining member 81 and the upper face 622a of the rear support frame 622 is ensured by the cylindrical member 183.

With the above configuration, when an impact is exerted on the cab 5, the separation of the cab 5 from the body frame 6 is restricted when the retaining member 181 hits the upper face 622a (around the through-hole 622s), but the impact of this restriction is moderated by the elastic force of the impact absorber 182, which is a spring member.

### Embodiment 3

A restrictor 208 used in the hydraulic excavator of Embodiment 3 of the present invention will now be described.

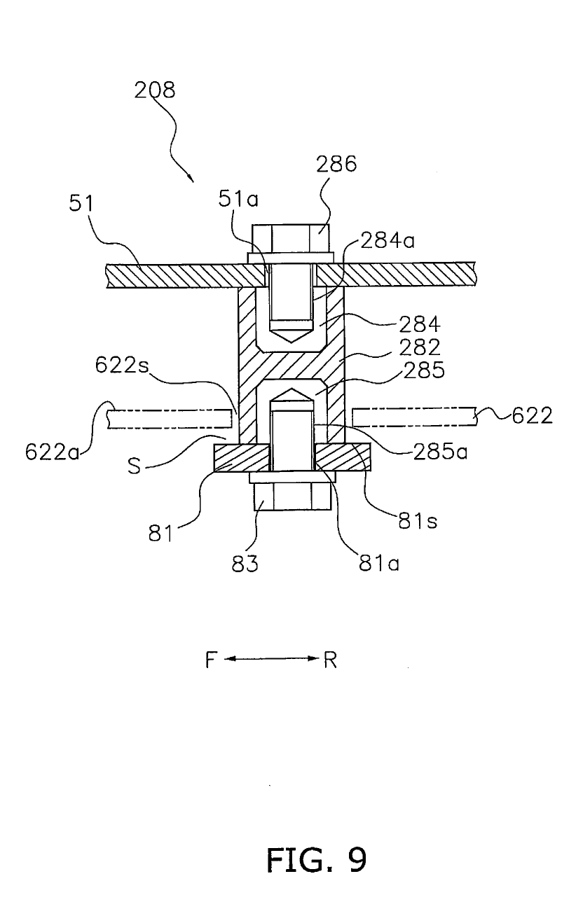

FIG. 9 is a cross section of the configuration of the restrictor 208 in Embodiment 3. The restrictor 208 in Embodiment 3 has the retaining member 81 and an impact absorber 282.

As in Embodiment 1, the retaining member 81 is disk shaped, is disposed lower than the upper face 622a of the rear support frame 622, and is formed larger in diameter than the through-hole 622s. A gap S is formed between the retaining member 81 and the upper face 622a.

The impact absorber 282 is a rubber member formed in a cylindrical shape. The impact absorber 282 is disposed through the through-hole 622s so that its axis extends in the up and down direction. The impact absorber 282 is disposed between the floor frame 51 and the retaining member 81.

The impact absorber 282 is fixed to the floor frame 51 via a first metal member 284. A concave portion is formed in the center of the upper end face of the impact absorber 282. The first metal member 284 is disposed in the concave portion and is bonded to the impact absorber 282. A threaded hole 284a is formed in the first metal member 284 in the up and down direction. A bolt 286 inserted from above the floor frame 51 through the through-hole 51a is threaded into the hole 284a to fix the impact absorber 282 to the floor frame 51.

Also, the impact absorber 282 is fixed to the retaining member 81 via a second metal member 285. A concave portion is formed in the center of the lower end face of the impact absorber 282. The second metal member 285 is disposed in the concave portion and is bonded to the impact absorber 282. A threaded hole 285a is formed in the second metal member 285 in the up and down direction. A bolt 83 inserted from below the retaining member 81 through the through-hole 81a is threaded into the hole 285a to fix the impact absorber 282 to the retaining member 81.

With the above configuration, when the cab 5 is subjected to an impact, the cab 5 is restricted from separating from the body frame 6 because the retaining member 81 hits the upper face 622a (the periphery of the through-hole 622s), but the impact of this restriction is moderated by the elastic force of the impact absorber 282, which is a rubber member.

### Embodiment 4

Next, a restrictor 308 used in the hydraulic excavator in Embodiment 4 of the present invention will be described.

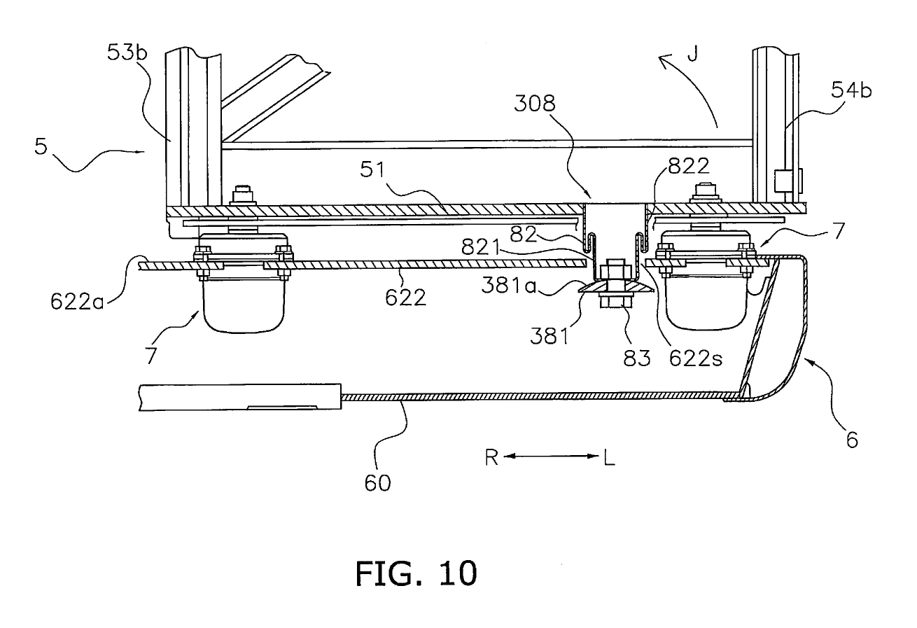

FIG. 10 is a cross section of the configuration of the restrictor 308 in Embodiment 4. The restrictor 308 in Embodiment 4 has a retaining member 381 and the impact absorber 82.

The retaining member 381 of the restrictor 308 in Embodiment 4 differs from the restrictor 8 in Embodiment 1 in the shape of the retaining member 381.

A curved surface 381a is formed on the cab 5 side (the side opposite the through-hole 622s) of the retaining member 381. The curved surface 381a is formed such that its position gradually becomes lower moving from the center toward the outer periphery.

Forming the curved surface 381a prevents the retaining member 381 from coming into one-sided contact around the periphery of the through-hole 622s when the cab 5 is tilted in the left and right direction (for example, in the direction of the arrow J) with respect to the body frame 6 due to an impact exerted on the hydraulic excavator 100.

The retaining member 381 on which the curved surface 381a is formed as in Embodiment 4 may be used in place of the retaining members 81 and 181 described in Embodiments 1 to 3.

### Embodiment 5

A restrictor 408 used in the hydraulic excavator of Embodiment 5 of the present invention will now be described.

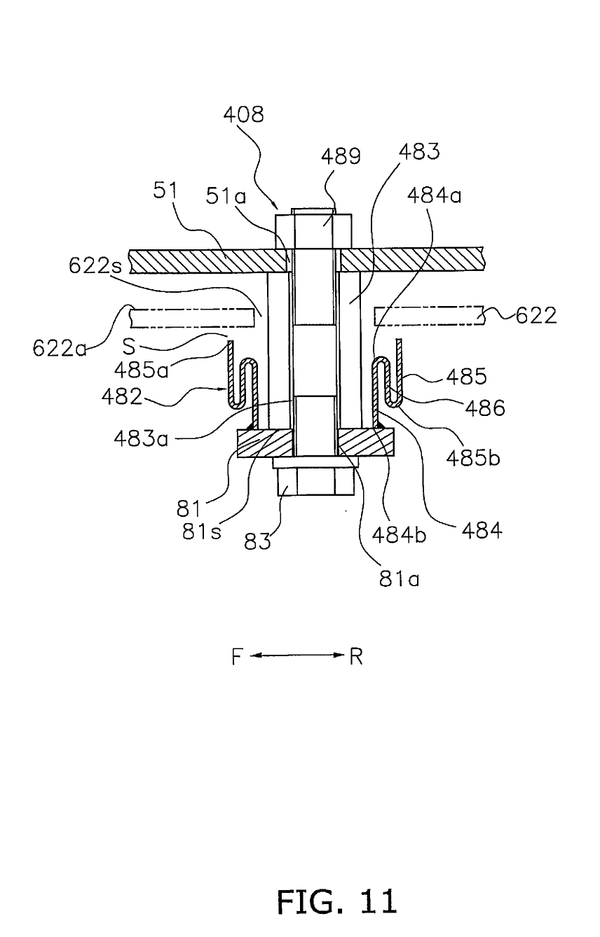

FIG. 11 is a cross section of the configuration of the restrictor 408 in Embodiment 5. The restrictor 408 in Embodiment 5 has the retaining member 81, an impact absorber 482, and a cylindrical member 483.

The retaining member 81 is similar to that of the first embodiment in that it is disk shaped, and is formed from a metal, for example. The retaining member 81 is disposed lower than the upper face 622a of the rear support frame 622, and is formed to have a diameter larger than that of the through-hole 622s.

The impact absorber 482 is provided on the cab 5 side of the retaining member 81 and lower than the upper face 622a (the through-hole 622s).

As in Embodiment 1, the impact absorber 482 has a substantially cylindrical shape in which two steel pipes of different diameters appear to be overlapping, and the central axes of the cylinders are disposed in the up and down direction.

As shown in FIG. 11, the impact absorber 482 is formed from steel pipe and has a first cylindrical section 484, a second cylindrical section 485, and a connecting portion 486.

The lower end 484b of the first cylindrical section 484 is fixed to the retaining member 81 by welding or the like.

The second cylindrical section 485 is formed in a larger diameter than the first cylindrical section 484. The second cylindrical section 485 is disposed coaxially with the first cylindrical section 484. The lower end 485b of the second cylindrical section 485 is located lower than the upper end 484a of the first cylindrical section 484.

The diameter of the second cylindrical section 485 is larger than the through-hole 622s, and a gap S is formed between the upper end 485a of the second cylindrical section 485 and the upper face 622a.

The connecting portion 486 connects the upper end 484a of the first cylindrical section 484 and the lower end 485b of the second cylindrical section 485. The connecting portion 486 is cylindrical in its middle in the up and down direction, and its upper end curves inward and connects to the upper end 484a of the first cylindrical section 484, while the lower end of the connecting portion 486 curves outward and connects to the lower end 485b of the second cylindrical section 485. Since the connecting portion 486 is curved and connects the first cylindrical section 484 and the second cylindrical section 485, the impact absorber 482 has elasticity.

The cylindrical member 483 is inserted into the through-hole 622s and is disposed between the floor frame 51 and the retaining member 81. A threaded hole 483a that goes through in the up and down direction is formed in the central portion of the cylindrical member 483.

The cylindrical member 483 is fixed to the lower side of the floor frame 51 by threading the bolt 489, which is inserted into the through-hole 51a from above the floor frame 51, into the threads at the upper part of the screw hole 483a. When the bolt 83 inserted into the through-hole 81a from under the retaining member 81 is threaded into the threads formed at the lower part of the screw hole 483a, this fixes the retaining member 81 to the lower side of the cylindrical member 483.

With the above configuration, when an impact is exerted on the cab 5, the cab 5 is restricted from separating from the body frame 6 because the impact absorber 482 hits the upper face 622a, and the impact in this restriction is lessened by elastic force.

### Embodiment 6

Next, a restrictor 508 used in the hydraulic excavator in Embodiment 6 of the present invention will be described. The restrictor 508 in Embodiment 6 differs from the restrictor 408 in Embodiment 5 in the configuration of the impact absorber.

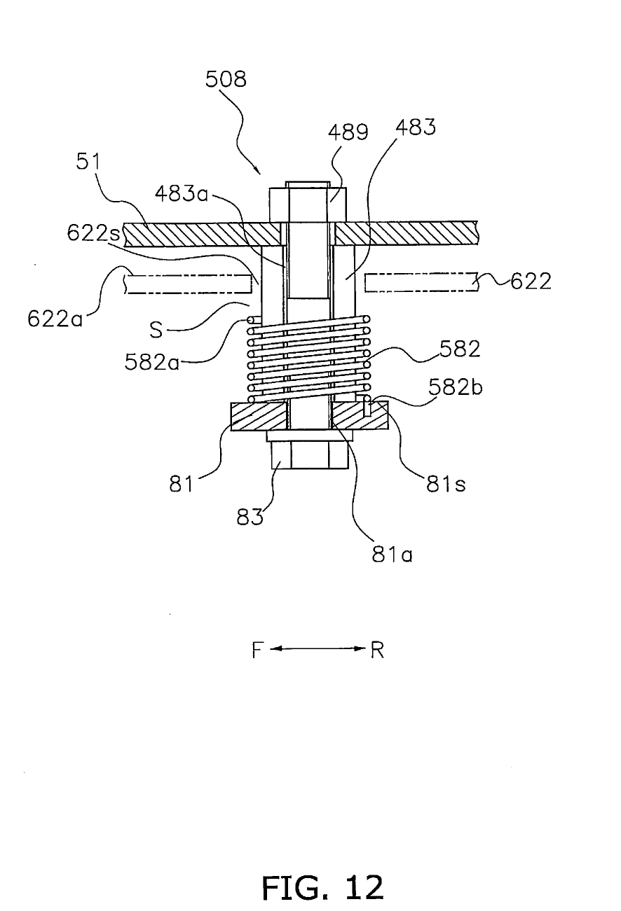

FIG. 12 is a cross section of the configuration of the restrictor 508 in Embodiment 6. The restrictor 508 in Embodiment 6 has the retaining member 81, an impact absorber 582, and the cylindrical member 483.

The retaining member 81 is the same as in Embodiment 5. Also, as in Embodiment 5, the cylindrical member 483 is fixed to the floor frame 51 with the bolt 489, and is fixed to the retaining member 81 by the bolt 83.

The impact absorber 582 is a coiled spring member, and is disposed on the outside of the cylindrical member 483 so as to surround the cylindrical member 483. The diameter of the impact absorber 582 is larger than the diameter of the through-hole 622s. The lower end 582b of the impact absorber 582, which is a spring member, is fixed to the retaining member 81. In a state in which the hydraulic excavator 100 is stopped, a gap S is formed between the upper end 582a of the impact absorber 582 and the upper face 622a.

With the above configuration, when an impact is exerted on the cab 5, the cab 5 is restricted from separating from the body frame 6 because the impact absorber 582 hits the upper face 622a, and the impact in this restriction is lessened by elastic force.

### Embodiment 7

Next, a restrictor 608 used in the hydraulic excavator in Embodiment 7 of the present invention will be described. The restrictor 608 in Embodiment 7 differs from the restrictor 508 in Embodiment 6 in the configuration of the impact absorber.

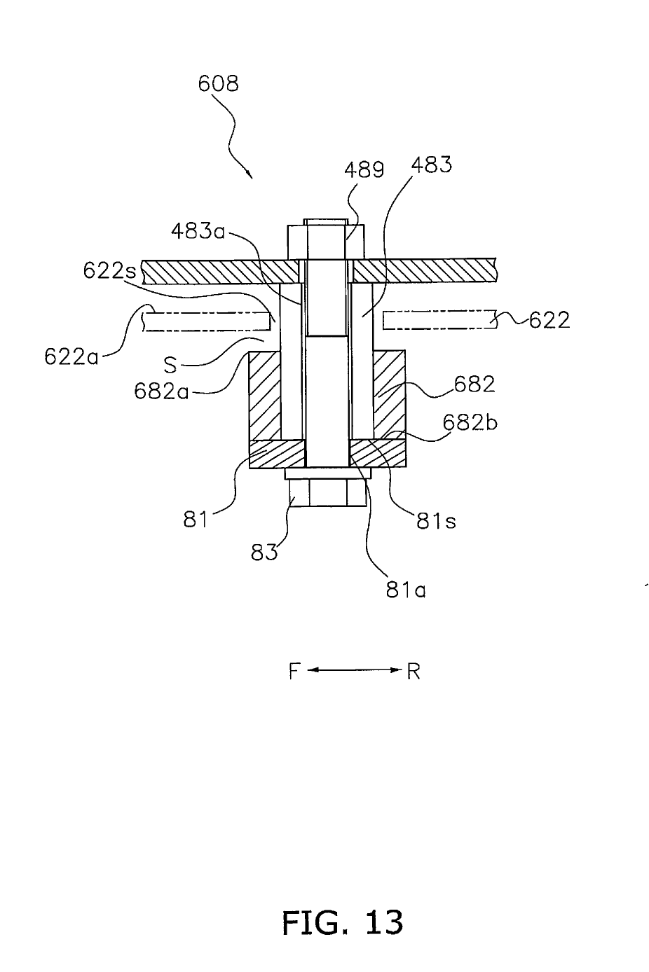

FIG. 13 is a cross sectional configuration diagram of the restrictor 608 in Embodiment 7 of the present invention.

The restrictor 608 in Embodiment 7 has the retaining member 81, an impact absorber 682, and the cylindrical member 483.

The impact absorber 682 of the restrictor 608 in Embodiment 7 is a rubber member, unlike the impact absorber 582 in Embodiment 6.

The impact absorber 682, which is a rubber member, is cylindrical and is disposed around the outer periphery of the cylindrical member 483. The diameter of the impact absorber 682 is larger than the diameter of the through-hole 622s. The impact absorber 682 is disposed lower than the upper face 622a. The lower end 682b of the impact absorber 682 is in contact with the upper face 81s of the retaining member 81. A gap S is formed between the upper end 682a of the impact absorber 682 and the upper face 622a.

With the above configuration, when an impact is exerted on the cab 5, the cab 5 is restricted from separating from the body frame 6 because the impact absorber 682 hits the upper face 622a, and the impact in this restriction is lessened by elastic force.

### Embodiment 8

Next, a restrictor 708 used in the hydraulic excavator in Embodiment 8 of the present invention will be described.

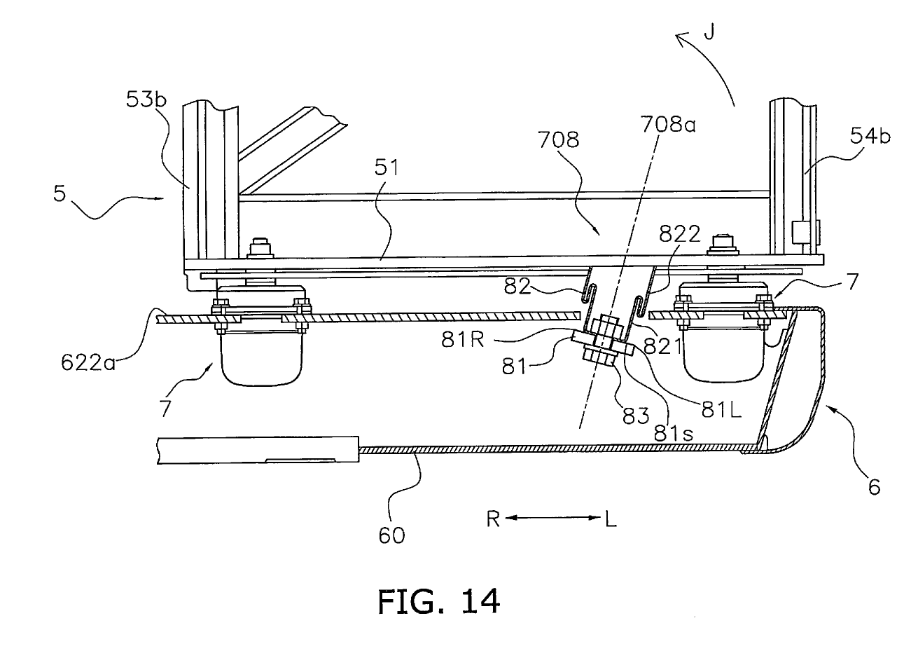

FIG. 14 is a cross sectional configuration diagram of the restrictor 708 in Embodiment 7 of the present invention. The restrictor 708 shown in FIG. 14 is the product of attaching the restrictor 8 in Embodiment 1 to the floor frame 51 in an inclined state.

As shown in FIG. 14, the restrictor 708 is disposed so that its center axis 708a is inclined in the left direction L as it goes upward.

The retaining member 81 is inclined so that the end 81R on the right direction R side of the upper face 81s is positioned higher than the end 81L on the left direction L side. In a state in which the hydraulic excavator 100 is stopped, the impact absorber 82 is inclined so as to hold the retaining member 81 in an inclined state. The center axis of the first cylindrical section 821 and the second cylindrical section 822 of the impact absorber 82 coincides with the central axis 708a.

The restrictor 708 in this embodiment can exhibit the following effect by being inclined with respect to the vertical direction.

If the hydraulic excavator 100 has tipped to the left direction L side, the cab 5 comes into contact with the ground, etc., and the cab 5 inclines with respect to the body frame 6 in the direction of the arrow J and tries to separate from the body frame 6. If the cab 5 is inclined with respect to the body frame 6, the restrictor 708 is also inclined, so that when the retaining member 81 hits the upper face 622a of the body frame 6, the retaining member 81 is parallel to the upper face 622a.

Therefore, the retaining member 81 can be prevented from coming into one-sided contact with the upper face 622a.

The restrictors 108, 208, 308, 408, 508, and 608 in Embodiments 2 to 7 above may be disposed so that their central axis is inclined as in Embodiment 8.

### Embodiment 9

Next, a restrictor 808 used in the hydraulic excavator in Embodiment 9 of the present invention will be described.

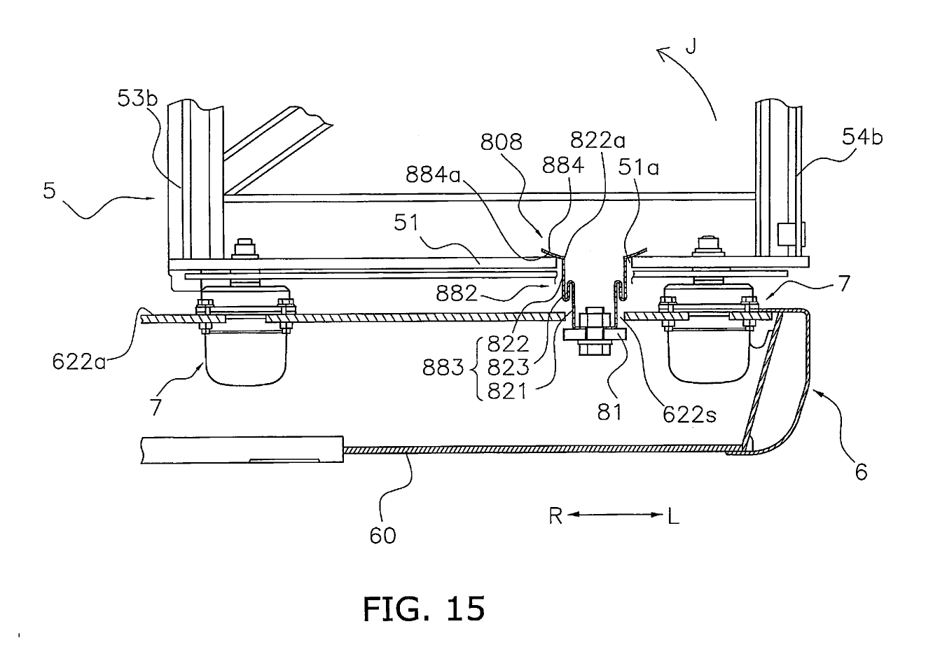

FIG. 15 is a cross sectional configuration diagram of the restrictor 808 in Embodiment 9. As shown in FIG. 15, the restrictor 808 in Embodiment 9 has the retaining member 81 and an impact absorber 882. The impact absorber 882 has an insertion component 883 that is inserted into the through-hole 622s, and a protruding portion 884. The insertion component 883 has a first cylindrical section 821, a second cylindrical section 822, and a connecting portion 823, and has the same configuration as the impact absorber 82 in Embodiment 1.

In Embodiment 9, unlike Embodiment 1, the upper end 822a of the second cylindrical section 822 is not fixed to the floor frame 51, and the protruding portion 884 is provided to the upper end 822a.

The protruding portion 884 is formed so as to extend outward from the whole periphery of the upper end 822a beyond the through-hole 51a.

The lower face 884a of the protruding portion 884 is curved so that its position becomes higher moving toward the outer peripheral side. The lower face 884a hits the edge of the through-hole 51a.

The restrictor 808 in Embodiment 9 has a configuration in which the protruding portion 884 is provided to hold the second cylindrical section 822 on the floor frame 51.

With the above configuration, when an impact is exerted on the cab 5, the cab 5 is restricted from separating from the body frame 6 because the retaining member 81 hits the upper face 622a (the periphery of the through-hole 622s), but the impact in this restriction is lessened by the elastic force of the impact absorber 882.

Forming the lower face 884a so as to be curved prevents the protruding portion 884 from coming into one-sided contact with the periphery of the through-hole 51a when the cab 5 is inclined in the left and right direction (such as in the direction of the arrow J) with respect to the body frame 6 due to an impact applied to the hydraulic excavator 100.

Features, Etc,

(1)

As shown in FIGS. 7 to 15, the hydraulic excavator 100 (an example of a work vehicle) in Embodiments 1 to 9 comprises the cab 5, the body frame 6, and the restrictor 8, 108, 208, 308, 408, 508, 608, 708, or 808. The body frame 6 has the base component 60 and the rear support frame 622 (an example of a support frame) that is provided on the upper side of the base component 60 and supports the cab 5. The restrictor 8, 108, 208, 308, 408, 508, 608, 708, or 808 is provided to the floor frame 51 of the cab 5 and is disposed between the base component 60 and the floor frame 51. The restrictor 8, 108, 208, 308, 408, 508, 608, 708, or 808 has the retaining member 81, 181, or 381 and the impact absorber 82, 182, 282, 482, 582, 682, or 882. The retaining member 81, 181, or 381 is disposed on the lower side of the rear support frame 622. The impact absorber 82, 182, 282, 482, 582, 682, or 882 is disposed on the cab 5 side of the retaining member 81, 181 or 381.

At least some of the impact generated in the cab 5 by restriction in the event that the hydraulic excavator 100 topples can be absorbed by providing an impact absorber to the restrictor 8, 108, 208, 308, 408, 508, 608, 708, or 808. Therefore, the impact generated in the cab 5 can be lessened, and the frame of the cab 5 need not be made of a thick material, so the thickness of the frame can be reduced.

Therefore, it is possible to further reduce the weight of the cab 5.

(2)

The hydraulic excavator 100 (an example of a work vehicle) in Embodiments 1 to 9 further comprises the dampers 7. As shown in FIG. 6, the dampers 7 are provided to the body frame 6 and support the cab 5, and also damp any vibrations generated in the cab 5.

Vibration and impact occurring in the cab 5 can be lessened during normal use of the hydraulic excavator 100, such as traveling and working.

Also, if the hydraulic excavator 100 should topple or collide with a rock or the like, the restrictor 8, 108, 208, 308, 408, 508, 608, 708, or 808 can restrict the cab 5 from separating from the body frame 6.

(3)

As shown in FIGS. 2, 5 and 6, the hydraulic excavator 100 (an example of a work vehicle) in Embodiments 1 to 9 further comprises the work implement 4 disposed on the body frame 6. The restrictor 8, 108, 208, 308, 408, 508, 608, 708, or 808 is provided on the opposite side from the work implement 4.

The side of the cab 5 on which the work implement 4 is not provided is more likely to be subjected to an impact, so the restrictor 8, 108, 208, 308, 408, 508, 608, 708, or 808 is provided on the opposite side from the work implement 4, which allows separation of the cab 5 from the body frame 6 to be effectively restricted.

(4)

As shown in FIGS. 7 to 10 and 14, in the hydraulic excavator 100 (an example of a work vehicle) in Embodiments 1 to 4 and 8, the impact absorber 82, 182, or 282 of the restrictor 8, 108, 208, 308, 708 is fixed directly or indirectly to the floor frame 51 of the cab 5.

When the cab 5 moves away from the body frame 6 due to an impact, the retaining member 81, 181, or 381 hits the rear support frame 622 (the periphery of the through-hole 622s) of the body frame 6 from below, and movement of the cab 5 is restricted. This contact causes the impact absorber 82, 182, or 282 to be pulled, and the impact can be lessened by the elastic force of the impact absorber 82, 182, or 282.

(5)

As shown in FIG. 7, with the hydraulic excavator 100 (an example of a work vehicle) in Embodiment 1, the impact absorber 82 has the first cylindrical section 821, the second cylindrical section 822, and the connecting portion 823. The first cylindrical section 821 is fixed to the retaining member 81. The second cylindrical section 822 is fixed to the floor frame 51 of the cab 5, and its lower end 822b is located lower than the upper end 821a of the first cylindrical section 821.

An elastic force is generated by the bending of the connecting portion 823 of the impact absorber 82, which softens the collision of the retaining member 81 against the rear support frame 622.

(6)

With the hydraulic excavator 100 (an example of a work vehicle) in Embodiment 2, as shown in FIG. 8, the impact absorber 182 is a spring member. The upper end 182a of the impact absorber 182 is fixed to the floor frame 51 of the cab 5, and the lower end 182b is fixed to the retaining member 181.

Providing the impact absorber 182, which is a spring member, means that the collision of the retaining member 181 against the rear support frame 622 can be softened by the elastic force of the spring member.

(7)

With the hydraulic excavator 100 (an example of a work vehicle) in Embodiment 3, as shown in FIG. 9, the impact absorber 282 is a rubber member. The impact absorber 282 is fixed to the floor frame 51 of the cab 5 via the first metal member 284 that is bonded to the impact absorber 282 and fixed to the floor frame 51 of the cab 5, and is also fixed to the retaining member 81 via the second metal member 285 that is bonded to the impact absorber 282 and fixed to the retaining member 81.

Providing the impact absorber 282, which is a rubber member, means that the collision of the retaining member 181 against the rear support frame 622 can be softened by the elastic force of the rubber member.

(8)

With the hydraulic excavator 100 (an example of a work vehicle) in Embodiment 4, as shown in FIG. 10, the curved surface 381a (an example of an upper face) of the retaining member 381 is curved so that its position becomes lower moving toward the outer peripheral side.

The portion of the retaining member 381 that collides with the rear support frame 622 (around the through-hole 622s) of the body frame 6 is curved. This makes it less likely that the retaining member 381 will come into one-way contact with the rear support frame 622 when the cab 5 is inclined with respect to the body frame 6.

(9)

As shown in FIGS. 11 to 13, with the hydraulic excavator 100 (an example of a work vehicle) in Embodiments 5, 6, and 7, the restrictor 408, 508, or 608 further has the cylindrical member 483 (an example of a linking member) that links the floor frame 51 and the retaining member 81. The impact absorber 482, 582, or 682 is fixed to the retaining member 81 and is disposed lower than the rear support frame 622 (an example of a support frame).

When the cab 5 moves away from the body frame 6 due to an impact, the impact absorber 482, 582, or 682 hits the rear support frame 622 of the body frame 6 from below, and movement of the cab 5 is restricted. In this contact, the impact absorber 482, 582, or 682 is compressed, and the impact can be lessened by the elastic force of the impact absorber 482, 582, or 682.

(10)

As shown in FIG. 11, with the hydraulic excavator 100 (an example of a work vehicle) in Embodiment 5, the impact absorber 482 has the first cylindrical section 484, the second cylindrical section 485, and the connecting portion 486. The first cylindrical section 484 is fixed to the retaining member 81. The lower end 485b of the second cylindrical section 485 is positioned lower than the upper end 484a of the first cylindrical section 484. The connecting portion 486 connects the upper end 484a of the first cylindrical section 484 and the lower end 485b of the second cylindrical section 485.

An elastic force is generated by the bending of the connecting portion 486 of the impact absorber 482, which softens the collision of the impact absorber 482 against the rear support frame 622.

(11)

With the hydraulic excavator 100 (an example of a work vehicle) in Embodiments 6 and 7, as shown in FIGS. 12 and 13, the impact absorber 582 or 682 is a spring member or a rubber member.

Providing a spring member or a rubber member means that the collision of the impact absorber 582 or 682 against the rear support frame 622 can be softened by the elastic force of the spring member or the rubber member.

(12)

With the hydraulic excavator 100 (an example of a work vehicle) in Embodiment 8, as shown in FIG. 14, the retaining member 81 is disk shaped (an example of a plate shape), and the upper face 81s (an example of a main face) is disposed opposite the rear support frame 622 (an example of a support frame). The restrictor 708 is disposed such that the end 81R of the upper face 81s on the work implement 4 side is higher than the end 81L on the opposite side from the work implement.

Disposing the restrictor 708 so that it is inclined makes it less likely that the retaining member 81 will come into one-sided contact with the body frame 6 when the cab 5 is inclined toward the work implement 4 side with respect to the body frame 6.

(13)

With the hydraulic excavator 100 (an example of a work vehicle) in Embodiment 9, as shown in FIG. 15, the impact absorber 882 has the insertion component 883 and the protruding portion 884. The insertion component 883 is inserted into the through-hole 51a (an example of a through-hole) formed in the floor frame 51 of the cab 5. The protruding portion 884 is provided higher than the floor frame 51 and protrudes from the insertion component 883 so as to extend outward from the through-hole 51a. The protruding portion 884 is curved so as to have a higher position moving toward the outer peripheral side, and has a lower face 884a that makes contact around the through-hole 51a.

Since the protrusion 884 of the impact absorber 882 has the lower face 884a that curves toward the through-hole 51a, it is less likely that the impact absorber 882 will come into one-sided contact around the through-hole 51a when the cab 5 is inclined with respect to the body frame 6.

(14)

With the hydraulic excavator 100 (an example of a work vehicle) in Embodiment 9, as shown in FIG. 15, the insertion component 883 has the first cylindrical section 821, the second cylindrical section 822, and the connecting portion 823. The first cylindrical section 821 is fixed to the retaining member 81. The second cylindrical section 822 is inserted into the through-hole 51a, and its lower end 822b is located lower than the upper end 821a of the first cylindrical section 821. The connecting portion 823 connects the upper end 821a of the first cylindrical section 821 and the lower end 822b of the second cylindrical section 822.

An elastic force is generated by the bending of the connecting portion 823 of the impact absorber 882, and the collision of the impact absorber 882 against the rear supporting frame 622 can be softened.

### Other Embodiments

Embodiments of the present invention were described above, but the present invention is not limited to or by the above embodiments, and various modifications are possible without departing from the gist of the invention.

(A)

In Embodiments 1 to 9, one restrictor 8, 108, 208, 308, 408, 508, 608, 708, or 808 is provided, but two or more restrictors may be provided. For example, as shown in FIG. 6, the restrictor 8 of Embodiment 1 is disposed near the support 54b on the left face side of the rear support frame 622, but may also be disposed near the support 54a on the left face side of the front support frame 621.

The restrictor 8 may be provided in the vicinity below the support 54b (an example of a first cab frame) and the support 54a (an example of a second cab frame).

In this case, as described in Embodiment 1, since the support 54b is stiffer than the support 54a, the coefficient of elasticity of the impact absorber 82 of the restrictor 8 provided in the vicinity below the support 54b is set to be higher than the coefficient of elasticity of the impact absorber of the restrictor 8 provided in the vicinity below the support 54a.

Due to the difference in the coefficient of elasticity, when an impact is exerted on the cab 5, the impact exerted on the support 54b is greater than that on the support 54a, but since the support 54b is stiffer than the support 54a, the support 54b can stop the impact. For example, when driving the hydraulic excavator 100, the driver can focus on what is in front of the cab, so it is unlikely that there will be an impact caused by collision or the like on the front side of the cab, but since the driver cannot focus his attention to the rear, an impact is more likely on that side. In view of this, the weight of the cab 5 can be reduced as much as possible by making the front side support 54a, which is less likely to be subjected to impact, thinner than the back side support 54b, which is more likely to be subjected to impact. If an impact should be exerted on the thinner front support 54a, it can absorb this impact because its coefficient of elasticity is set lower.

In Embodiments 2 to 9, the restrictor 108, 208, 308, 408, 508, 608, 708, or 808 may be provided to the front support frame 621 as in the above description.

(B)

In the above embodiments and in (A) of the above-mentioned other embodiments, the restrictor 8, 108, 208, 308, 408, 508, 608, 708, or 808 was said to be provided to the rear support frame 622 and the front support frame 621, but the restrictor 8, 108, 208, 308, 408, 508, 608, 708, or 808 may be provided near the left end of the middle support frame 624.

In the above embodiments, as shown in FIG. 4, the middle support frame 624 is disposed between the support 54a and the support 54c in the longitudinal direction, but the middle support frame 624 may be disposed below the support 54c, and the restrictor 8, 108, 208, 308, 408, 508, 608, 708, or 808 may be disposed near the support 54c.

(C)

In the above embodiments and in (A) of the above-mentioned other embodiments, the restrictor 8, 108, 208, 308, 408, 508, 608, 708, or 808 is provided on the opposite side from the work implement 4, but may also be provided on the work implement 4 side.

(D)

In Embodiments 1 to 9, the hydraulic excavator 100 is used as an example of a work vehicle, but this is not the only option, and it may instead be a wheel loader, a bulldozer, a motor grader, or the like.

### INDUSTRIAL APPLICABILITY

The work vehicle of the present invention has the effect of ensuring the required strength and reducing the weight of the cab, and can be widely applied, for example, to hydraulic excavators, wheel loaders, bulldozers, motor graders, and the like.

1. A work vehicle, comprising:
a cab;
a body frame including a base component, and a support frame provided on an upper side of the base component, the support frame supporting the cab; and
a restrictor provided to a floor frame of the cab, the restrictor being disposed between the base component and the floor frame, the restrictor including
a retaining member disposed on a lower side of the support frame, and
an impact absorber disposed on a cab side of the retaining member.

2. The work vehicle according to claim 1, further comprising
a damper provided to the body frame, the damper supporting the cab, and the damper being configured to damp vibrations occurring in the cab.

3. The work vehicle according to claim 1, further comprising
a work implement disposed on the body frame, the restrictor being provided on an opposite side from the work implement.

4. The work vehicle according to claim 3, wherein
the cab includes
a first cab frame formed in an up and down direction on a side face of an opposite side of the cab from a side on which the work implement is disposed, and
a second cab frame formed in the up and down direction on the side face of the opposite side of the cab from the side on which the work implement is disposed, the second cab frame being lower in stiffness than the first cab frame,
the restrictor is provided in a vicinity below the first cab frame and in a vicinity below the second cab frame, and
a coefficient of elasticity of the impact absorber of the restrictor provided in the vicinity below the second cab frame is lower than a coefficient of elasticity of the impact absorber of the restrictor provided in the vicinity below the first cab frame.

5. The work vehicle according to claim 1, wherein
the impact absorber is fixed directly or indirectly to the floor frame of the cab.

6. The work vehicle according to claim 5, wherein
the impact absorber includes
a first cylindrical section fixed to the retaining member,
a second cylindrical section fixed to the floor frame of the cab, a lower end of the second cylindrical section being positioned lower than an upper end of the first cylindrical section, and
a connecting portion connecting the upper end of the first cylindrical section and the lower end of the second cylindrical section.

7. The work vehicle according to claim 5, wherein
the impact absorber is a spring member,
an upper end of the impact absorber is fixed to the floor frame of the cab, and
a lower end of the impact absorber is fixed to the retaining member.

8. The work vehicle according to claim 5, wherein
the impact absorber is a rubber member,
the impact absorber is fixed to the floor frame of the cab via a first metal member bonded to the impact absorber and fixed to the floor frame of the cab, and
the impact absorber is fixed to the retaining member via a second metal member bonded to the impact absorber and fixed to the retaining member.

9. The work vehicle according to claim 5, wherein
an upper face of the retaining member is curved so that a position of the upper face becomes lower as an outer peripheral side is approached.

10. The work vehicle according to claim 1, wherein
the restrictor further includes a linking member linking the floor frame and the retaining member, and
the impact absorber is fixed to the retaining member and is disposed lower than the support frame.

11. The work vehicle according to claim 10, wherein
the impact absorber includes
a first cylindrical section fixed to the retaining member,
a second cylindrical section with a lower end positioned lower than an upper end of the first cylindrical section, and
a connecting portion connecting the upper end of the first cylindrical section and the lower end of the second cylindrical section.

12. The work vehicle according to claim 3, wherein
the impact absorber is a spring member or a rubber member.

13. The work vehicle according to claim 3, wherein
the retaining member is a plate-shaped member disposed such that a main face thereof is opposite the supporting frame, and
the restrictor is disposed such that an end of the main face on a side of the work implement is higher than an end on an opposite side from the work implement.

14. The work vehicle according to claim 1, wherein
the impact absorber includes
an insertion component inserted into a through-hole formed in the floor frame of the cab, and
a protruding portion provided above the floor frame, the protruding portion being formed so as to protrude from the insertion component to further outside than the through-hole, and
the protruding portion is curved so that its position becomes higher as an outer peripheral side is approached, and has a lower face coming into contact around a periphery of the through-hole.

15. The work vehicle according to claim 14, wherein
the insertion component includes
a first cylindrical section fixed to the retaining member,
a second cylindrical section inserted into the through-hole, a lower end of the second cylindrical section being located lower than an upper end of the first cylindrical section, and
a connecting portion connecting the upper end of the first cylindrical section and the lower end of the second cylindrical section.
